(19) United States
(12) Patent Application Publication
(10) Pub. No.: US 2005/0198824 A1
(43) Pub. Date: Sep. 15, 2005

(54) Rotary hair trimmer

(76) Inventor: Dennis J. White, Plainsboro, NJ (US)

Correspondence Address: Dennis J. White, 17 Nostrand Rd, Cranbury, NJ, 08512, US

(21) Appl. No.: 11/002,091

(22) Filed: Dec. 3, 2004

Related U.S. Application Data
(60) Provisional application No. 60/552,187, filed on Mar. 12, 2004.

(51) Int. Cl. B26B 19/00

(52) U.S. Cl. 30/29.5; 30/43.4

(57) ABSTRACT

This invention discloses a hair trimmer that cuts hair in convex areas of the body, such as nose and ears. It relies on a sickle cutter technology, which is a more efficient design over the common cylinder design. Two opposing discs rotate relative to each other. The discs have finger projections, which function to snip hair as the finger projections meet.

### FIELD OF INVENTION

This invention relates to electric razors, in particular to electric razors designed for safe and efficient hair trimming in concave areas of the body, such as nose or ear cavities.

### BACKGROUND OF THE INVENTION

Hair trimmers have been in use for many years. It is common practice to trim hair in ears and nostrils for esthetic and health reasons. Current methods accomplish this task by use of fixed razor blades, scissors, manual trimmers, or electric trimmers.

Many of the trimmers in use today either have a cylinder design or a foil design to cut hair. The foil designs are common in many of the electric shavers currently produced. Foil shavers utilize a screen covering a movable cutting edge. The screen is held into intimate contact with the cutting edge.

Foil shavers allow hair to enter through one side of screen via small openings. Meeting hair on the other side of screen is a moving cutting edge. The fast movement of the cutting edge trims hair at screen height.

The general problem with the cylinder designs is that much of the cutting surface is sacrificed due to the solid portion of screen. Any portion of the screen that is solid is a portion that is not accessible to hair cutting.

The foils may work on an open area of the skin. But unfortunately, the foil cutter must be made very small to be useful in a confined area such as the nose. Cylinder trimmers are the most common design for hair trimming in the nose. The cylinder has slots with openings to allow hair to fall in place and an internal spinning razor to trim the hair that enters the cylinder. Inventors call the support member of the stationary cylinder, prongs.

However, because of these prongs, cylinder designs tend to be inefficient. Hair that contacts the prongs is not cut. Repeated motions of cyclic back and forward techniques are necessary to capture uncooperative residual hair. Thus, repeated strokes tend to be needed to usher hair into cutting area of cylinder. Extra time as well as skill is required.

Straight sickle cutters are sometimes presently used to trim hair that is readily accessible. It is not used in recessed areas such as the nose, because the sickle cutter is straight and relatively long. Straight sickle cutters are usually an accessory of the foil electric razors.

The present invention disclosed herein has all working edges directly in contact with hair; that is, nonworking support surfaces touching the skin are minimal. There are no impeding surfaces such as prongs or screens. It is especially efficient for trimming hair in recessed areas such as the nose.

In U.S. Pat. No. 6,505,403, Andrews describes a manually operated trimmer. This device is manual, thus requiring a more exacting and slower use of instrument.

Its use is direction specific to engage working area and will not cut 360° about head of instrument. It must be continually repositioned to be effective.

U.S. Pat. No. 5,655,301, Dickson reveals a trimmer that will cut 360°. The disadvantage to this cylinder style tip is that only half of the 360° tip is open to cut hair. The other half of cylinder is the closed half referred to in his specification as prongs. The prongs exist symmetrically dispersed throughout the entire cylinder. Collectively, the prongs actually make up the cylinder. There is no effective cutting area where the prongs exist.

In U.S. Pat. No. 4,958,432, Marshall invents a hair trimmer that will cut along a long axis of trimmer. The disadvantage with this device is that the cap has a great percentage of its surface as supportive and a far lesser percentage active cutting tip. Therefore, this device is inefficient by design.

In U.S. Pat. No. 4,805,390, Majkrzak shows a sickle knife. The knife is straight and not circular. As such, it only cuts in one forward direction and not backward or in lateral excursions

In U.S. Pat. No. 6,272,752, Pino reveals a hair trimmer to be used in small recessed areas. Its long working surface allows efficient cutting on flat or concave areas. It has a drawback of being less efficient in convex areas.

In U.S. Pat. No. 6,493,941 B1, Wong discloses an invention to keep the cutting edge of blade close to a foil by spring pressure. His invention does not circumvent the inherent shortcomings of a foil cutter.

### OBJECTS AND ADVANTAGES

The object of this invention is to disclose an apparatus that is effective and more efficient than any of the present devices on the market for trimming nose hair. All of the present cylinder and foil type trimmers require repeated strokes in the exact same area to trim hair. By repeating these strokes more hair is finally removed.

Certain devices are very directional sensitive. The trimmer must then be repeatedly applied in just slightly different directions to be effective.

The problem of the cylinder design is that hair is impeded from entering into the working area. It is impeded by the thickness and width of the supporting prongs. The cylinder trimmer's disadvantage is that the prong itself contacts the hair causing in to fall over. Thus, hair does not stand up and is not readily received into the cutting area.

This disclosed invention's cutting edge terminates in a dental form or finger projection along its arcuate outside shape. The advantage of the present disclosure is that all hair neatly falls between the guides; the guides do not have to be precisely directed. This inventor refers to these guides as finger projections. Since no supporting prongs exist, there is no impedance of hair entering into the cutting area of the rotary trimmer. All the outside circular edge consists of working area. Non working areas, such as prongs, do not exist in this invention, which is a unique feature for mechanical hair trimmers.

Since the hair will readily enter into cutting or working area of the rotary trimmer, the trimmer will cut hair equally well as the trimmer is advanced forward or as it comes out.

It does not have to press hard against the soft tissue. Intimate contact is all that is necessary, and because of this, hair is not pushed down. If hair is not pushed down and readily lies between the finger projections, then it is easily cut.

This cutter is thus efficient because repeated strokes are not necessary.

Since the trimmer will cut any hair falling between the finger projections, hair may be trimmed with trimmer away from skin. Longer hair can be trimmed. This rotary hair trimmer works equally well on short or longer hair.

Its circular design allows for accommodating recessed or convex areas.

### BRIEF DESCRIPTION OF THE DRAWING

FIG. 1 shows top perspective of invention

FIG. 2 shows a lateral perspective of invention.

### DETAILED DESCRIPTION OF THE PREFERRED EMBODIMENT

With references to the drawings, the following descriptive narrative explains invention.

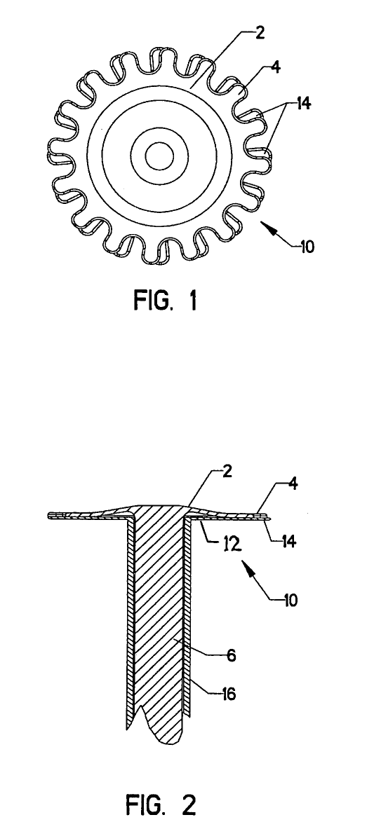

FIG. 1 shows a top perspective of rotary hair trimmer, 10. Rotary hair trimmer consists of a stationary disc, 2 with finger projections, 4. FIG. 2 reveals that disc, 2 is held in position by being attached to stationary shaft, 6. FIG. 2 shows a lateral perspective of rotary hair trimmer, 10. FIG. 2 reveals a rotatable disc, 12, also with finger projections, 14. This rotatable disc, 12 is attached to a hollow shaft, 16. This hollow shaft, 16 is outside the stationary shaft, 6 and is rotational in relation to stationary shaft, 6.

The finger projections of both discs are held in intimate contact. In other words, projection, 14 slides past projection, 4 while always being in full contact with projection, 4.

The rotation motion of shaft, 16 along with attached disc, 12 in relation to stationary shaft, 6 and attached disc, 2 can be either an oscillating back and forth rotation or direct one direction spin.

In use, the circular edge of rotary hair trimmer is placed near skin so that hair to be cut is placed between finger projections, 4 and 14. Rotational movement of shaft, 16 will cause rotation of disc, 12. Rotational movement of disc, 12 will cause movement between the finger projections, 4 and 14, because the two discs, 2 and 12 share a common rotation point. Hair trapped between working surfaces of the finger projections, 4 and 14 is readily cut.

The preferred embodiment would be motor driven. The power source would be conventional electric motor with gear and lever drive.

The present disclosure herein is a type of sickle cutter. This sickle cutter is completely circular around its working head. It cuts the full circumference of the working head.

It may also be designed so that only part of the outside arcuate form ends in finger projections. This design would allow for cutting on a portion of the circumference or the rotary trimmer. This design would allow manufactures to incorporate a safe area of the trimmer that would press against the tissue and not cause an irritation.

The finger projection of the rotary hair trimmer may be made of a metal or a strong polymer.

A spring may be used additional force to keep the working surfaces of the finger projections, 4 and 14 together.

1. A hair trimmer device comprising one disc with at least part of its outside edge being of circular arc form and terminating in an array of finger projections with working surface on one side of finger projections and a second disc with similar outside terminal circular edge also terminating in finger projections with working surface on one side of finger projections, said discs movably held and rotational about a common center point relative to outside said arc form of said discs, and working surfaces of finger projections of each said disc face each other and held in intimate contact, whereas, rotational movement between said discs trims hair falling between working edges of finger projections.

2. Discs have finger projections completely around outside of said discs.

3. Discs are made of metal

4. Working surfaces of finger projections of said discs are proximated by spring force.

5. A hair trimmer, comprising one fixed disc terminating in finger projections on at least part of its outside edge, a second moveable disc terminating with finger projections on at least part of its outside edge;
finger projections of both said discs share common arc path,
finger projections of both said discs are in intimate contact,
said movable disc rotates about axis common to both said fixed disc finger projections and said movable disc finger projections whereby hair is trimmed in path of proximating finger projections upon said rotation of movable disc.
